(19) United States
(12) Patent Application Publication
(10) Pub. No.: US 2004/0054903 A1
(43) Pub. Date: Mar. 18, 2004

(54) Distributed processing

(75) Inventors: Brian Quentin Monahan, Bristol (GB); Keith Alexander Harrison, Monmouthshire (GB); Martin Sadler, Bristol (GB); Along Lin, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/437,976

(22) Filed: May 15, 2003

(30) Foreign Application Priority Data
May 18, 2002 (GB) 0211469.2

(51) Int. Cl. H04L 9/00

(52) U.S. Cl. 713/168

(57) ABSTRACT

A software application to be performed by a second computing resource on behalf of a first computing resource is transmitted to and installed on the second computing resource, and is run thereon using inputs received via a user interface. The software application includes a verification module for creating a sequence of data consisting of a plurality of choice points defining the sequence of events which occurred during the running of the software application. The sequence of data is transmitted to the first computing resource together with the result of the execution of the software application, the first computing resource being adapted to check the sequence of data to determine whether or not the software application was executed correctly.

### FIELD OF THE INVENTION

This invention relates to a method and apparatus for permitting effective distribution of processing tasks across one or more computing resources for performance of those processing tasks on behalf of one or more other computing resources.

### BACKGROUND OF THE INVENTION

There are an increasing number of circumstances in which an individual may wish to apply or register on-line for a product or service. For example, banks and other financial institutions are increasingly offering potential customers the opportunity to make credit applications over the Internet, and receive decisions thereon on-line, without the need for paper-based communications.

In such cases, a software application is generally run on the bank or financial institution's server using information received from a prospective customer in response to questions. Thus, when the software application has been initiated, it transmits a first question, e.g. ‘What is the applicant's name?’, over the Internet to the prospective customer's computing equipment, such that an appropriate enquiry/prompt appears on their screen. The prospective customer enters their answer and transmits it back to the server, in response to which another question or set of questions is generated and transmitted to the prospective customer for response. As the prospective customer's responses are received, the software application is run using such responses, until the application is complete and a result is obtained.

It will be appreciated that, in many cases, this procedure will inevitably result in the transmission of confidential and potentially sensitive customer information back and forth across an open electronic communications network, with the inevitable risk of “eavesdropping” or unauthorised access being obtained thereto. Although such repeated transfer of information across the network will generally be protected by encryption within a secure session, there still exists a credible risk because of the sustained duration of the conversation over the network, i.e. the longer the conversation, the greater the opportunity for eavesdropping, traffic analysis and the like. In addition, a sustained secure session is expensive in terms of computational effort and time since all communication is encrypted in at least one direction and thus has to be decrypted at the opposite end. This means that both client and server are performing cryptographic operations, even if encryption is used in only one direction.

Another important consideration is the high server processing requirement to run several instances of the software application in parallel, and the relatively large bandwidth required to support the reciprocal parallel communications between the server and a plurality of prospective customers.

Of course, one way in which all of the above-mentioned problems can be overcome would be for a copy of the software application itself to be transmitted to each prospective customer, to be run locally by their respective central processing units (or CPU's), with only the result/outcome of running the application being transmitted back to the originating server. As a result, the need for a secure session of sustained duration is substantially eliminated. In addition, of course, the host server CPU capacity and bandwidth requirements to handle several customer inputs in parallel are minimised.

However, the distribution of running the software application to a collection of unknown computational resources introduces another set of problems. It will be appreciated that the originator of the software application will necessarily employ one or more “trusted” central servers, in the sense that they will include one or more safety mechanisms or features intended to prevent accidental or deliberate security violations, which enables the party running those servers to have a predetermined high level of trust in the integrity of their operation and the results obtained.

However, the party relying on the results of running a software application cannot place the same level of trust in the correct running of the software application and the results obtained if the application is processed by a number of unknown (and therefore untrusted) computational resources. Thus, some form of mechanism is required to ensure that a task has been carried out correctly by an unknown computational resource.

Another area in which computational effort may be distributed or ‘load-balanced’ across a collection of unknown (and therefore potentially untrustworthy) computational systems, as opposed to focussing the computing effort onto one or more relatively expensive, trusted central servers, is the use (paid or otherwise) of people's spare CPU cycles via screensavers and the like.

It is well known that most computer users employ screensavers which are simple software packages for preventing damage to a computer screen caused by prolonged inactivity. Such packages tend to run automatically after a predetermined period of time has elapsed during which there has been no activity on a computer screen, and continue to run until such activity recommences. While the screensaver is running, i.e. during each period of inactivity, very little processing power is employed, which results in a number of “spare” (or wasted) CPU cycles. Given that there are millions of regular computer users throughout the world, it will be appreciated that there are collectively millions of potentially “spare” CPU cycles available for use each day.

SETI, the electromagnetic Search for Extra-Terrestrial Intelligence, is a relatively young science which seeks to detect direct radio evidence of other technological civilisations in the cosmos, and employs giant radio telescopes using sensitive microwave receivers and powerful computers to scan nearby stars for artificially generated signals of intelligent alien origin. In order to have any chance of successfully receiving such signals, the instruments must be pointing in exactly the right direction and be tuned to exactly the right frequency which, in turn, requires the systematic scanning of the instruments across a wide spatial range (of small intervals) and the systematic tuning of the signal receivers across a wide spectral range, again of small intervals. It will be apparent that such instruments therefore generate substantial amounts of data which is required to be analysed. In fact, the amount of data generated is far greater than could hope to be analysed, even by the most powerful supercomputers.

This problem has at least partially been overcome by recruiting volunteers throughout the world to install a screensaver module on their computing equipment, which screensaver module includes the processing software required to analyse chunks of data generated by the signal scanners. As such, chunks of such data are transmitted to each of the volunteers' computing equipment, and analysed during periods of inactivity of the equipment. The results are then returned to the originating source for collation. In effect, the originators have harnessed the processing power of 1.85 million personal computers around the world and in so doing have created a very powerful supercomputer.

Once again, this type of distributed processing raises the issue of whether or not the results returned by a plurality of unknown computational resources can be trusted. In order to overcome this problem, each “chunk” of data to be analysed is transmitted to at least two volunteer computational resources, such that, if both resources return the same result for a chunk of data, the analysis of that chunk of data can be reasonably be considered to be relatively trustworthy.

However, as well as requiring at least double the number of computational resources to carry out the work, this approach would not be suitable for increasing the trustworthiness of results obtained from running a software application using confidential or sensitive information received from a first party, because it would be required to be transmitted to a second party's (potentially untrustworthy) computational resource (across a potentially untrustworthy network).

### SUMMARY OF THE INVENTION

In accordance with one aspect of the present invention, there is provided a method of using a second computing resource to perform a processing task on behalf of a first computing resource, the method comprising the following steps carried out by the second computing resource: receiving first code to enable a processor of the second computing resource to perform the processing task and second code to enable the processor of the second computing resource to create a sequence of data representative of validity of execution of said processing task; executing said first code and said second code to obtain results of the processing task and the sequence of data representative of validity of execution of the processing task; and, if transmitting results of the processing task to the first computing resource, also transmitting the sequence of data.

In accordance with a further aspect of the present invention, there is provided a carrier medium carrying computer readable code for controlling a second computing resource to perform a processing task on behalf of a first computing resource, said computer readable code comprising: first code to enable a processor of the second computing resource to perform the processing task; and second code to enable the processor of the second computing resource to create a sequence of data representative of validity of execution of said processing task.

In accordance with a further aspect of the present invention, there is provided a method by which a first computing resource obtains performance of a processing task from a second computing resource, the method comprising the following steps carried out by the first computing resource: transmitting to the second computing resource first code to enable a processor of the second computing resource to perform the processing task and second code to enable the processor of the second computing resource to create a sequence of data representative of validity of execution of said processing task; receiving from the second computing resource results of the processing task and a sequence of data representative of validity of execution of the processing task by the second computing resource; and determining from the sequence of data whether the processing task was validly executed by the second computing resource.

In accordance with a further aspect of the present invention, there is provided apparatus for permitting a second computing resource to perform a processing task on behalf of a first computing resource, the apparatus comprising processing means for installation on said second computing resource to enable said second computing resource to perform a specified processing task on behalf of said first computing resource, means for transmitting from said second to said first computing resource the one or more results of said processing task, means for causing said second computing resource to create a sequence of data representative of predetermined events and/or facts relating to the execution of said processing task by said second computing resource, means for transmitting said sequence of data to said first computing resource, and verification means for determining from said sequence of data whether or not said processing task was executed correctly.

Also in accordance with a further aspect of the present invention, there is provided a method of enabling a second computing resource to perform a processing task on behalf of a first computing resource, the method comprising the steps of installing processing means on said second computing resource to enable said second computing resource to perform a specified processing task on behalf of said first computing resource, executing said processing task and transmitting from said second to said first computing resource the one or more results of said processing task, causing said second computing resource to create a sequence of data representative of predetermined events and/or facts relating to the execution of said processing task by said second computing resource, transmitting said sequence of data to said first computing resource, and determining from said sequence of data whether or not said processing task was executed correctly.

It will be apparent that the present invention is primarily concerned with somehow allowing ‘untrusted’ clients to share the burden of work of ‘trusted’ servers. This approach provides a way of reducing the inevitable encryption and process switching costs currently involved in the above-mentioned types of network communication, as well as reducing the opportunity for attack, although it will be appreciated that in many cases, there will still be a need to use encryption and cryptography services at same level—the present invention is not intended to replace these services altogether. It should be noted that the terms ‘trusted’ and ‘untrusted’ are used subjectively in the context of this specification simply as comparative as opposed to technical terms. Any computing resource unknown to another computing resource is effectively going to be ‘untrusted’ thereby since they will not have any reason to trust them. Similarly, a user's own computing equipment will be considered ‘trusted’ (as far as that user is concerned) because it is their own equipment.

The underlying concept of the present invention is for the second computing resource (or ‘client’) to generate sufficient evidence to enable the first computing resource or server to do sufficient checks that the delivered result meets the server's requirements. It will become apparent throughout this specification that the concept of evidence in the context of the present invention is general and not limited to formal proof In fact, the notion or definition of evidence may be chosen according to the computational problem at hand and will be dependent on a number of factors, such that operational trade-offs can be made in many circumstances between the level of trust (and therefore the amount and quality of evidence) required and the computational resources available to perform the checking function.

There are a number of advantages to distributing processing tasks across a collection of computing resources as opposed to focusing the computing effort onto a small number of expensive, trusted central servers. Such advantages include the fact that the local computing resources can maintain their own private data, with minimum risk of leakage or exposure thereof. Further, privacy can be enhanced because servers do not need to hold everyone's private data globally, which data may then need to be replicated (with further potential for leakage and exposure, as well as back-up failure). The present invention overcomes the problem of enabling the server to confirm that such processing has been correctly carried out.

The advantages of the approach proposed by the present invention include:

That there is a more balanced division of labour between client and server.

In view of the fact that the client has sent all of the explicit evidence required, there is no expensive server-side search process to generate such evidence. The checking process carried out by the server is strictly deterministic and can be arranged to fail as soon as any error is found (i.e. there is no “backtracking” on the server—only on the client).

The client bears the full computational cost of constructing the evidence. This means that the server does not need to waste time in attempting futile evidence generation for, say, negative decisions. An honest client is unlikely to waste time and money by sending proposed evidence for something which does not actually work. Thus, bandwidth requirements can also be reduced, since most of the attempts that end up being transmitted to the server will be intended to work.

Although it is still possible for a dishonest client to spend its resources in constructing very long, redundant evidence that ultimately fails anyway, these long sequences still have to be transmitted to the server, such that there is still a natural cost to the client, whereas the server can reject the evidence relatively cheaply because:

the sequence happens to be too long (i.e. exceeding some predefined bound

if the sequence does not claim a positive outcome, there is no point in checking it

the sequence contains an erroneous piece of evidence that does not match

A distributed approach to processing is taken which could enable the deployment of ever more sophisticated e-services.

The apparatus and method of the present invention can, of course, be further enhanced if required by the introduction of cryptographic techniques and protocols for use in communication taking place between the first and second computing resource.

### BRIEF DESCRIPTION OF THE DRAWINGS

An embodiment of the present invention will now be described by way of example only and with reference to the accompanying drawing, in which:

FIG. 1 is a schematic block diagram of apparatus according to an exemplary embodiment of the present invention.

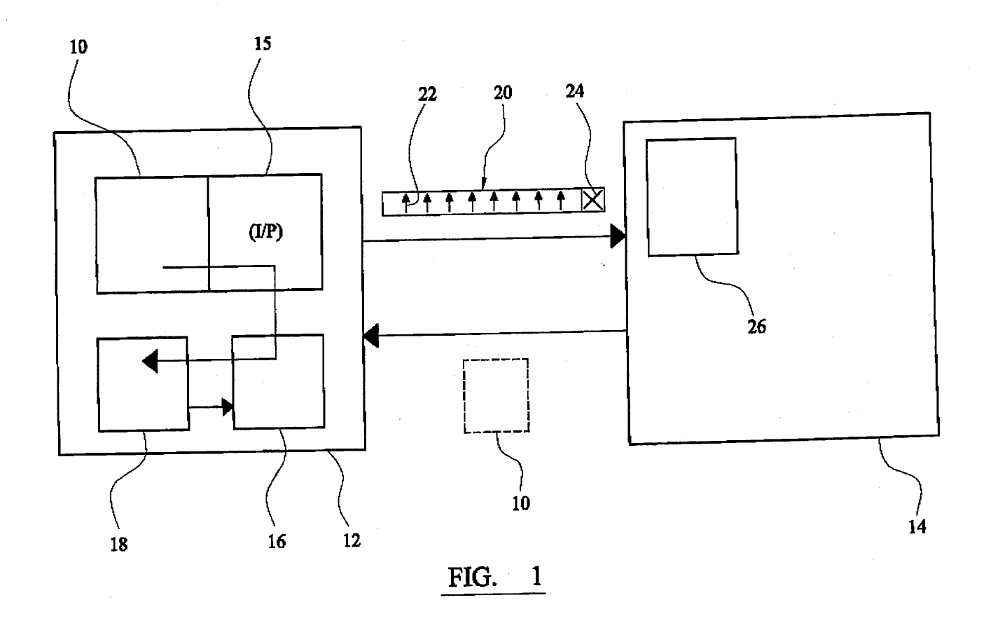

### DETAILED DESCRIPTION OF AN EMBODIMENT OF THE INVENTION

For the following, consider a software application 10, such as a credit enquiry software program for use by a bank or financial institution in loan or mortgage applications. In response to an enquiry received on-line from a potential customer 12, the financial institution server 14 transmits a copy of the credit enquiry software 10 to the potential customer's computing equipment 12 to be installed and run locally thereon using inputs received via a user interface 15.

The software program 10 may be implemented in the form of an ‘applet’ which is a known term in the art for a software program that has limited features, requires limited memory resources and is usually portable between operating systems, such as a software program which can be distributed as an attachment in a World-Wide Web document and executed locally by a web browser or similar application, with its file system and network access severely restricted to prevent accidental or deliberate security violations. As stated above, the term ‘applet’ is well known in the art and will not be discussed in any further detail in this specification.

In any event, a software program of any type is typically implemented with a standard execution pattern according to the language code used to implement it, and is generally run as a sequence of ‘loops’ or events according to the inputs it receives. Thus, for example, a typical software program may be implemented with a loop which states:

IF ‘X’ THEN GOTO A
IF ‘Y’ THEN GOTO B

In other words, if the input is ‘X’, execute sequence ‘A’ and if the input is ‘Y’, execute the sequence ‘B’. ‘A’ and ‘B’ may also be ‘IF’ statements, or they may be any other type of standard coding loop, such as a ‘FOR’ statement (e.g. “FOR ‘A’ DO ‘M’ ELSE DO ‘N’”) or the like. In one case, of course, ‘A’ and ‘B’ may actually comprise respectively the positive and negative results of the process. It will be well understood by a person skilled in the art that irrespective of the coding language used or the nature of the software program itself, any program will generally include a number of points at which it makes a decision or choice as to which event or instruction to action next, based on the inputs received and/or the results obtained from previous loops and sequences in the program, and such points may be termed ‘choice points’.

The credit enquiry software transmitted to the potential customer's computing equipment (together with appropriate configuration data, etc.) includes a verification module 16 which is installed on the customer's computing equipment 12 and used to verify to the financial institution's server that the software program 10 was carried out correctly. Once again, the structure of the verification module 16, especially if it is implemented in software, will be dependent on many factors, including the structure of the software program itself, the coding language used, the party who actually implements the module, etc., and it will be described in generic functional terms only. Many possible implementations of the verification module will be apparent to persons skilled in the art, and will not be discussed in any great detail herein, although specific examples will be referred to later.

In general terms, the verification module 16 monitors the inputs to and operation of the software program (which is essentially executing a set of rules) and builds up a database 18 of facts defining the process. In other words, the verification module defines a decision-making algorithm so that any run of the program 10 produces a trace output of what it did—which trace output constitutes evidence which witnesses the means by which the final decision was made. In one embodiment of the present invention, the decision-making algorithm (i.e. trace generator) could be written in, for example, Prolog or (more practically) Java. The system of rules underlying the decision-making operation (run by the program 10) should effectively be decidable—i.e. the trace generator would finitely terminate in all cases with either a positive or negative decision (result) being reached.

Thus, at the beginning of the program, the software program may enter its first sequence by means of which the user may be asked to enter their full name. When the program enters this sequence, this may be detected by the verification module and recorded in the database 18. Entry of the user's name may cause the program to enter a second sequence in which the user is asked to enter their date of birth. Entry into this second sequence would also be detected by the verification module and recorded in the database, and so on.

Upon completion of the running of the software program, the database effectively comprises a log of the facts defining the process, in the form:

“Executed first FOR loop”
“Arrived at Branch A”
“Input X entered” (upon which entry into Branch B may be dependent)
“Arrived at Branch B”
-----------------
etc.

and the database is used to construct a long message 20 consisting of choice points 22 for transmission together with the result 24 of the program execution to the financial institution's server 14 for verification. The choice points may be presented in the form of a linear sequence which can be checked off by an application 26 run on the host server 14. This linear sequence (or trace) effectively comprises a transcript of the sequence of events which occurred during the running of the software program and, as such, would be difficult to forge because even if the precise implementation of the software program could be ascertained, exactly which choice points required to satisfy the verification process by the host server would be virtually impossible to ascertain. For additional security, the software program may be adapted to digitally sign the transcript, so as to prevent tampering therewith after the program has been run, in which case, a digital certificate would also be installed on the customer's computing equipment 12 at the same time as the software program 10.

The verification application 26 (or trace verification algorithm) run by the host's server in respect of the transcript received from the potential customer's computing equipment may employ a finite state machine, which effectively follows a graph-like pattern to ensure reliability and consistency. Thus, one section of the finite state machine may implement the statement “Event A is always followed by Branch C1 or Branch C2, If not—ERROR”. Thus, when the verification application runs through the linear sequence of events and comes across Event A, it checks to see if it is followed by Branch C1 Branch C2. If it is, the verification process continues along the sequence to the next choice point. If, however, Event A is followed by anything other than Branch C1 or Branch C2, the verification process returns a result indicating that the software program was incorrectly executed and disregards the result received therefrom. In any event, the trace verification algorithm simply matches the given sequence to check if each element is a valid step of the decision-making algorithm (i.e. the software program 10), based on an underlying system of rules, and it will be appreciated that this checking process does not require the server to perform any general rule search—it only checks that the specified rules have been correctly applied, and as such, the checking process can be made as complicated or simple by the nature and number of rules required to have been correctly applied.

The number of choice points selected for use in the verification sequence transmitted to the host server will be dependent on the level of trust required thereby. Some applications will simply require that most of the program was executed correctly, whereas other applications will require a high level of trust whereby there is virtually no doubt that the entire program was executed correctly without unauthorised interference.

In another embodiment of the present invention, the code provided with the software program for building up a database of facts defining the process of executing the software program, may not be provided as a separate verification module. Instead, the main program may be annotated as required to collect the necessary data. In yet another embodiment of the invention, the software compiler may be adapted to output a message every time it sees that an “if” statement and/or a “for” loop, for example, is entered. Such a message may include the branch taken at each point, if required by the application in question. Thus, the compiler can be adapted to output mechanically the evidence required by the host server.

In addition to the obvious benefits with regard to maintaining customer confidentiality, even though the host server still needs to check the sequence returned by a customer's computer after a software program has been executed thereby, this process still requires substantially less CPU capacity and bandwidth than running the program itself using inputs received from the customer's computer. Obviously, in many cases, the circumstances in which the host server needs to check the execution of the software program can be limited to certain specific conditions. For example, in the case of a credit enquiry for a loan or mortgage application, the host server only really needs to check the integrity of the software program execution in cases where the result is “Yes—credit approved”.

In the foregoing specification, the invention has been described with reference to specific exemplary embodiments thereof It will, however, be apparent to a person skilled in the art that various modifications and changes may be made thereto without departing from the broader spirit and scope of the invention as set forth in the appended claims. Accordingly, the specification and drawings are to be regarded in an illustrative, rather than a restrictive, sense.

1. A method of using a second computing resource to perform a processing task on behalf of a first computing resource, the method comprising the following steps carried out by the second computing resource:
receiving first code to enable a processor of the second computing resource to perform the processing task and second code to enable the processor of the second computing resource to create a sequence of data representative of validity of execution of said processing task;
executing said first code and said second code to obtain results of the processing task and the sequence of data representative of validity of execution of the processing task;
and, if transmitting results of the processing task to the first computing resource, also transmitting the sequence of data.

2. A method according to claim 1, wherein the first code enables the processor of the second computing resource to transmit results of the processing task to the first computing resource if the results contain certain predetermined parameters, but does not require the processor of the second computing resource to transmit results of the processing task to the first computing resource if the results contain other certain predetermined parameters.

3. A method according to claim 1, wherein said second code comprises a decision-making algorithm to ensure that every time said processing task is performed, a sequence of data representative of predetermined events and/or facts relating to the execution of said processing task is produced.

4. A method according to claim 3, wherein said second code adapts the processor to monitor inputs to and operation of said processing task, and to build up a database of facts defining the execution of said processing task from which said sequence of data is derived.

5. A method according to claim 3, wherein said decision-making algorithm terminates when a result is obtained from the execution of said processing task.

6. A method according to claim 1, further comprising the step of encrypting at least some of the results of the processing task and the sequence of data representative of validity of execution of the processing task prior to transmission to the first computing resource.

7. A method according to claim 6, wherein said encrypting step comprises digitally signing said sequence of data prior to transmission thereof to said first computing resource.

8. A method according to claim 7, wherein the step of receiving code further comprises receiving third code for controlling the processor of the second computing resource to install a digital certificate on said second computing resource.

9. A method according to claim 1, wherein the processing task comprises a plurality of control points to be executed, and creating a sequence of data representative of validity of execution of said processing task comprises identifying that a control point has been executed and generating an element of data for inclusion in said sequence of data indicative that said control point has been executed.

10. A carrier medium carrying computer readable code for controlling a second computing resource to perform a processing task on behalf of a first computing resource, said computer readable code comprising:
first code to enable a processor of the second computing resource to perform the processing task; and
second code to enable the processor of the second computing resource to create a sequence of data representative of validity of execution of said processing task.

11. A carrier medium as claimed in claim 10, wherein said second code comprises a decision-making algorithm to ensure that every time said processing task is performed, a sequence of data representative of predetermined events and/or facts relating to the execution of said processing task is produced.

12. A carrier medium as claimed in claim 11, wherein said second code adapts a processor to monitor inputs to and operation of said processing task, and to build up a database of facts defining the execution of said processing task from which said sequence of data is derived.

13. A carrier medium as claimed in claim 10, wherein said decision-making algorithm terminates when a result is obtained from the execution of said processing task.

14. A carrier medium as claimed in claim 10, said computer readable code further comprising third code for controlling the processor of the second computing resource to install a digital certificate on said second computing resource.

15. A carrier medium as claimed in claim 10, wherein the processing task comprises a plurality of control points to be executed, and wherein creating a sequence of data representative of validity of execution of said processing task comprises identifying that a control point has been executed and generating an element of data for inclusion in said sequence of data indicative that said control point has been executed.

16. A method by which a first computing resource obtains performance of a processing task from a second computing resource, the method comprising the following steps carried out by the first computing resource:
transmitting to the second computing resource first code to enable a processor of the second computing resource to perform the processing task and second code to enable the processor of the second computing resource to create a sequence of data representative of validity of execution of said processing task;
receiving from the second computing resource results of the processing task and a sequence of data representative of validity of execution of the processing task by the second computing resource; and
determining from the sequence of data whether the processing task was validly executed by the second computing resource.

17. A method as claimed in claim 16, wherein the determining step comprises comprising checking off each element of said sequence data in the order in which it is received.

18. A method as claimed in claim 17, wherein said checking off of the elements of said sequence of data occurs only if one or more predetermined results are received from said second computing resource.

19. A method as claimed in claim 17, wherein the determining step terminates in the event that an element of said sequence of data is determined to be missing or otherwise incorrect.

20. A method as claimed in claim 16, further comprising sending to the second computing resource third code for controlling the processor of the second computing resource to install a digital certificate on said second computing resource, and wherein at least some of the data received from the second computing resource is digitally signed by the second computing source, the method comprising the further step of decrypting the digitally signed data.

21. Apparatus for permitting a second computing resource to perform a processing task on behalf of a first computing resource, the apparatus comprising processing means for installation on said second computing resource to enable said second computing resource to perform a specified processing task on behalf of said first computing resource, means for transmitting from said second to said first computing resource the one or more results of said processing task, means for causing said second computing resource to create a sequence of data representative of predetermined events and/or facts relating to the execution of said processing task by said second computing resource, means for transmitting said sequence of data to said first computing resource, and verification means for determining from said sequence of data whether or not said processing task was executed correctly.

22. Apparatus according to claim 21, comprising a verification module for installation on said second computing resource and for defining a decision-making algorithm to ensure that every time said processing task is performed, a sequence of data representative of predetermined events and/or facts relating to the execution of said processing task is produced.

23. Apparatus according to claim 22, wherein said verification module is adapted to monitor inputs to and operation of said processing task, and build up a database of facts defining the execution of said processing task from which said sequence of data is derived.

24. Apparatus according to claim 22, wherein said decision-making algorithm terminates when a result is obtained from the execution of said processing task.

25. Apparatus according to claim 21, comprising a verification application run by said first computing resource for checking off each element of said sequence data in the order in which it is received.

26. Apparatus according to claim 25, wherein said verification application is adapted to check off the elements of said sequence of data only if one or more predetermined results are transmitted therewith by said second computing resource.

27. Apparatus according to claim 25, wherein said verification application is adapted terminate in the event that an element of said sequence of data is determined to be missing or otherwise incorrect.

28. Apparatus according to claim 21, wherein at least some of the data transmitted between said first and second computing resources is encrypted prior to such transmission.

29. Apparatus according to claim 21, comprising means for installation on said second computing resource and for digitally signing said sequence of data prior to transmission thereof to said first computing resource.

30. Apparatus according to claim 29, comprising means for installing a digital certificate on said second computing resource when said processing means is installed thereon.

31. A method of enabling a second computing resource to perform a processing task on behalf of a first computing resource, the method comprising the steps of installing processing means on said second computing resource to enable said second computing resource to perform a specified processing task on behalf of said first computing resource, executing said processing task and transmitting from said second to said first computing resource the one or more results of said processing task, causing said second computing resource to create a sequence of data representative of predetermined events and/or facts relating to the execution of said processing task by said second computing resource, transmitting said sequence of data to said first computing resource, and determining from said sequence of data whether or not said processing task was executed correctly.

32. A method according to claim 31, wherein said processing task comprises a plurality of control points, such as loops, procedures, conditionals, case selections, etc., to be executed, and said step of creating a sequence of data representative of predetermined events and/or facts relating to the execution of said processing task comprises the steps of identifying that a control point has been executed and generating an element of data for inclusion in said sequence of data indicative that said control point has been executed.

33. A method according to claim 32, wherein an element of data generated when a control point is executed includes data indicative of the outcome or result of execution of said control point.
